(19) United States
(12) Patent Application Publication
(10) Pub. No.: US 2011/0278834 A1
(43) Pub. Date: Nov. 17, 2011

(54) Protective order identification card and method for enforcement

(76) Inventor: John E. Oliveira, Scottsdale, AZ (US)

(21) Appl. No.: 12/780,414

(22) Filed: May 14, 2010

(51) Int. Cl. B42D 15/00; G06K 19/00

(52) U.S. Cl. 283/70; 235/487

(57) ABSTRACT

A protective order identification card and method for enforcement that assists law enforcement officials in quickly and efficiently assisting victims under the protective auspices of protective orders through the use of a dual-sided identification card and national information hotline number. The dual-sided identification card, coupled with the national information hotline number, displays relevant information regarding both the victim and offender to provide a necessary tool for assisting law enforcement personnel in enforcing protective orders regardless of jurisdiction.

### FIELD OF THE INVENTION

The present invention relates to a method to assist law enforcement officials in efficiently and quickly enforcing protective orders through the use of a dual-sided identification card pertaining to government-sanctioned protective orders containing photo and factual information about both parties involved with a protective order, and a national information hotline number.

### BACKGROUND OF THE PRESENT INVENTION

Protective orders are sometimes a victim's best chance at getting away from an abusive or otherwise violent individual. For example, U.S. Department of Justice statistics show that each year, about 4.5 million women are victims of violent crimes. Moreover, a substantial number of reported crimes perpetrated by lone offenders—about 29 percent—involved people such as boyfriends, former boyfriends, husbands and former husbands. Going further, experts have stated that women of all races, religions and walks of life are subject to such abuse. In the publication, “The Basics of Batterer Treatment, Common Purpose, Inc., Jamaica Plain, Mass.,” it was reported that one in five women victimized by a spouse or ex-spouse were subjected to the abuse over and over again. Of course, it not only is women and their children that are victims of such abuse or subject to the wide-array of crimes that are committed each day.

Trespassers, stalkers and other potentially dangerous individuals also cause fear and concern among all types of people. Perhaps it is a number of threatening phone calls. Or even a peeping Tom. But when a victim has finally had enough, or when someone gets beaten so bad that the situation is forced on all involved including children, an often sought after remedy is to seek a court-ordered protective order. The most commonly known type of protective order is the temporary restraining order. These protective orders are intended to create an official, court-ordered situation, where the offender is prohibited from engaging in various forms of contact and/or proximity to the victim.

However, statistics show that protective orders are frequently violated. In an extreme statistic, one U.S. government study stated that nearly 20 percent of domestic homicides occurred when the murderer was forbidden contact under a protective restraining order. Other less extreme violations also occurs at a strikingly frequent rate.

Current procedures for a vulnerable person to obtain a protective order are to file a petition with a county or comparable court system. Oftentimes, a protective order can be issued the same day so long as the alleged victim supports his or her claim with convincing evidence. Once the court issues a temporary restraining order, the next step is to serve the offender with a notice detailing the order. From that moment, the order is valid and the offender is forbidden to engage in whatever contact or proximity is stated in the court order. This temporary restraining order may then be valid until both parties can appear in court to haggle over a permanent restraining order.

While a protective order is a tool that can be used by a victim to keep a safe distance from an offender, they are not guaranteed to keep the offender at bay. As mentioned above, protective orders are often ignored. In addition, although the 1994 federal Violence Against Women Act gave police the authority to enforce protective orders from any jurisdiction, in practice there is a need for much more help. The reason is that in practice, it remains difficult for police to enforce protective orders because they are not provided a method for better information and verification. People often do not carry court documents with them, which makes verification and protection that much more difficult in practice.

Moreover, the US Supreme Court ruled in 2005 that a police department in Colorado was within its rights and duties when officers ignored a woman's plea for them to enforce a protective order. The woman's estranged husband ended up killing their three daughters. A simple and effective method for quickly verifying and reviewing protective orders in the field is necessary to place realistic conditions of enforcing protective orders into conjunction with federal law.

Currently, police officers need to jump through a number of hoops to enforce a protective order. The officer needs to verify the protective order and would normally have to access a state database or court system file. This always isn't easy to do on a quick basis, especially in the field. Even if the officer believed the victim's claims, the officer still must verify the various details of the protective order as well as verify the identity of the offender as well. All of these considerations also must take into account the reality that it remains highly inconvenient and impractical to require a victim to carry curt documents everywhere they go, especially since verification efforts of both the offender and victim would still be necessary.

Therefore, a need has been established for an identification card capable of verifying all of the elements necessary to quickly and effectively enforce a protective order at any time or location. A method that would perform this function could save lives by adding a fast and easy conduit for police officers to enforce protective orders from any jurisdiction in the country. By implementing a national hotline with a specifically crafted standard sized identification card that a victim may carry, along with a coded information strip on the card, the need of better enforcing and protecting those victims reliant on a protective order will be satisfied.

### SUMMARY OF THE INVENTION

The present invention is a method that provides law enforcement and others with quick and easy enforcement and identification tools useful in dealing with existing protective orders. The method of the present invention works on a number of levels. Generally, the levels of the method relate to the identification card, the information strip included in the identification card and a verification hotline. Each element to the overall method of the present invention compliment each other in order to provide the easiest, quickest and most efficient tool and procedure possible for police officials to enforce protective orders regardless of jurisdiction and at any time.

The identification card is two sided and is the size of a standard credit card. The front side of the card has a relatively current photo of the victim, along with standard identification items such as birth date, eye color and hair color. This element of the present invention helps properly identify the victim. The front of the card also dates when the protective order became valid and when it is set to expire. A protective order number also is displayed on the front of the identification card, as is the verification hotline telephone number. In an additional embodiment of the present invention, the front of the identification card features an official anti-forgery seal from the jurisdiction that originally issued the protective order.

The rear side of the identification card has a relatively current photo of the offender, along with standard identification items such as birth date, eye color and hair color. This element of the present invention helps properly identify the offender. In addition, the rear side of the identification card can include the offender's vehicle make, model and license plate number. Also, the specific terms of the protective order are displayed on the rear side of the identification card. A coded information strip such as a barcode or magnetic strip also is located there to provide an additional avenue of verification and authentication. An additional embodiment of the present invention can include a color code that bases its color on the circumstances involved.

Another element to the method of the present invention is to implement a national information hotline where law enforcement officials can call on the spot and at any time to verify the protective order number.

An additional element of the present invention is that the victim can use the dual-sided identification card to secure emergency supplies and services in certain circumstances. An example of this is when a victim makes the move to escape from an abusive situation. In this example, a participating merchant can use the card—possibly but not limited to the coded identification strip combined with the identification element of the overall card—to provide shelter, fuel, food or other necessity to a victim in such a dire situation.

### BRIEF DESCRIPTION OF THE DRAWINGS

FIG. 1 is a view of the front side of the identification card (15) of the present invention.

FIG. 2 is a view of the rear side of the identification card (15) of the present invention.

FIG. 3 is a flow chart detailing how the method works.

### DETAILED DESCRIPTION OF THE PREFERRED EMBODIMENT

The present invention is a method that consists of an identification card (15) combined with various procedures, including a national information hotline. Overall, the method of the present invention is designed to assist law enforcement personnel in enforcing any protective orders issued by a court regardless of U.S. jurisdiction in a quick and more efficient manner. In essence, the method of the present invention specifically relates to a dual-sided identification card along with a national information hotline. These two elements coincide with other procedurally related aspects of the method of the present invention.

In the preferred embodiment, the dual-sided identification card (15) is comparable in size and durability to a standard identification card such as a driver's license or credit card. This embodiment permits the dual-sided identification card (15) to be easily stored in a pocket, purse, wallet or even worn via a lanyard. In fact, the easy-to-carry aspect of the dual-sided identification card (15) is important to the method of the present invention because this element will relieve a victim of the burden and impractical inconvenience of carrying court documents and paperwork everywhere he or she travels.

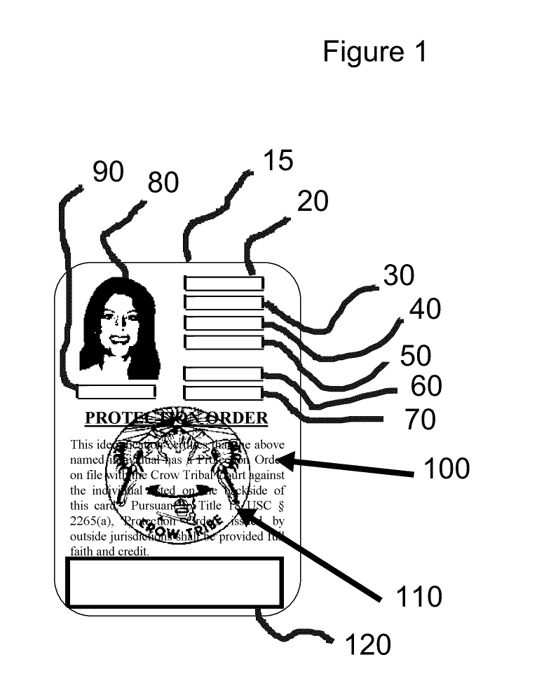

As we see in the figures, the dual-sided identification card (15) indeed features information on the front and back. The front of the dual-sided identification card (15) as seen in FIG. 1 displays information that is very useful for law enforcement to verify and gain important valid information quickly. FIG. 1 shows us that the front side provides distinct information about the victim. This information can allow law enforcement officials to quickly verify the identity of the victim as a step in the method of the present invention to better enforce protective orders. Information that may be included on the front side of the card is the victim name (20), victim birthdate (30), victim eye color (40) and victim hair color (50). A current victim photograph (80) also is displayed much in the same way as a standard driver's license. This information provides relatively easy and efficient victim identification. The front side as seen in FIG. 1 also displays the protective order issue date (60) and protective order expiration date (70). That information also can play an important role in verifying if a protective order is being violated.

For example, if a police officer responds to a claim that a protective order is being violated, the officer would take a look at the dual-sided identification card (15). The officer would likely first view the victim photograph (80), victim eye color (40) and victim hair color (50). Once it is established that the complaining individual is the same person as seen in the dual-sided identification card (15), the officer would then view the information pertaining to the protective order issue date (60) and protective order expiration date (70). If the protective order expiration date (70) is deemed to have expired, then it would appear that no enforcement is necessary in respect to the enforcement of the actual protective order. Of course, if a crime is being committed regardless, the police officer can still enforce the law. On the other hand, if the protective order expiration date (70) has not tolled, then the police officer can continue with the procedure as defined by the method of the present invention.

FIG. 1 also shows that a protective order number (90) is displayed on the front of the card. This element provides an additional bit of information for law enforcement personnel. Along that line, we see in FIG. 1 that the front of the dual-sided identification card (15) contains basic jurisdictional information (100) regarding the jurisdiction where the protective order was issued. For example, if a county court in Montana issued a protective order, the basic jurisdictional information (100) would mention that. Moreover, the front of the dual-sided identification card (15) as seen in FIG. 1 also would display the issuing jurisdiction's official anti-forgery seal (110). This element is no different in scope as an anti-forgery mechanism contained on a standard driver's license designed to prevent unauthorized duplication or production.

Additional information contained on the front of the dual-sided identification card (15) is the national information hotline contact number (120). This aspect of the present invention provides a telephone number that law enforcement personnel can easily call. Once a law enforcement official calls the national information hotline contact number (120), he or she will receive prompt verification about the veracity of the protective order. An embodiment of this feature would allow the law enforcement official to dial in the protective order number (90) as seen in FIG. 1 once the national information hotline contact number (120) is used.

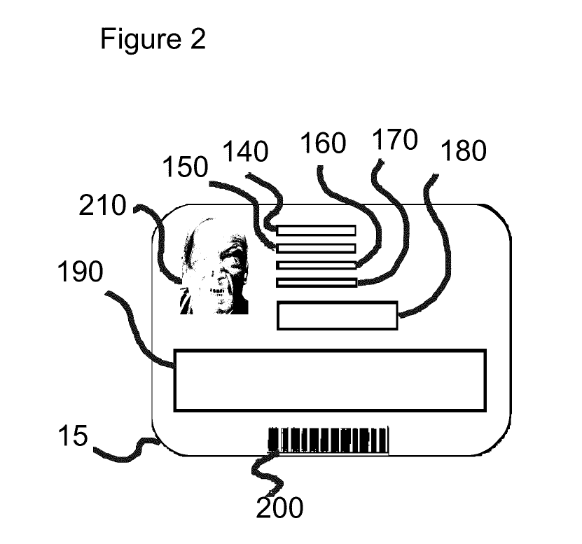

Meanwhile, the back of the dual-sided identification card (15) devotes much of its space to information pertaining to the offender as seen in FIG. 2. Much like the front of the dual-sided identification card (15), FIG. 2 shows us that the back contains information, but this side focuses on the offender. The offender name (140), offender birthdate (150), offender eye color (160) and offender hair color (170) may be included on the back as seen in FIG. 2. A current offender photograph (210) also is displayed much in the same way as a standard driver's license. This information provides relatively easy and efficient offender identification and efficiently speeds up the verification and ultimate protective-order enforcement process. In addition, an embodiment of the present invention also can include offender vehicle information (180) on the backside of the card as seen in FIG. 2. This element can provide even more evidence and proof of the protective-order situation to assist law enforcement personnel.

In FIG. 2, we also see an example of the protection order terms (190). This aspect assists law enforcement personnel because it succinctly and clearly lists the relevant details of the protective order. For example, the protective order terms (190) can state that an offender is prohibited from being within 1,000 feet of the victim. It also can state that the offender is prohibited from any phone, email or other communication with victim. Whatever the protective order terms (190) may be, it can be listed on the back of the dual-sided identification card (15). This aspect of the present invention will further assist law enforcement personnel. For example, after verifying the identity of both the victim and offender, a police officer can then look at the protective order terms (190) to check to see if an infraction had even occurred. If an offender is ordered to remain 1,000 feet from the victim, and the offender is at 1,500 feet, a police officer will know that the protective order was not violated. However, if the offender is closer than 1,000 feet from the victim, then the police officer will know that a protective order was indeed violated and can act accordingly.

An additional embodiment of the present invention includes a coded identification strip (200) as seen in FIG. 2. This element of the present invention can contain all of the relevant information pertaining to the protective order in a coded fashion. Similar to a magnetic strip or barcode, law enforcement official or other relevant individual can swipe the card on a designated decoding machine to access the information contained in the card. This can be used for final verification during enforcement processing or as a backup system in case the national information contact number (120) fails for whatever reason. It also can simply be used as an alternative method of verification.

An additional embodiment of the present invention relating to the coded identification strip (200) as seen in FIG. 2 relates to what amounts to a voucher system. In this embodiment of the present invention, the coded identification strip (200) can be used, especially in conjunction with the other details included in the overall dual-sided identification card (15), to secure necessary items for the victim under certain circumstances. The preferred embodiment for this additional aspect of the present invention is that a victim escaping from an abusive situation can use the card to secure such items as food, shelter and fuel from participating merchants or organizations.

An additional embodiment of the present invention includes changing the color of the rear side of the dual-sided identification card (15) to reflect the nature of the offender's criminal acts or potential danger. This aspect of the present invention provides a quick and efficient reference to law enforcement officials in the veracity and circumstances of the offense.

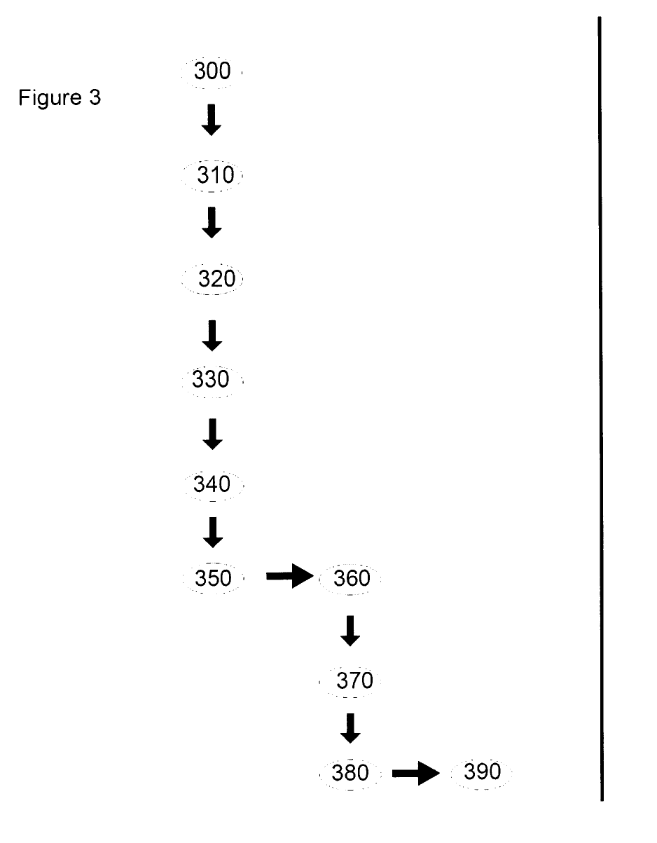

In FIG. 3, we see a flow chart detailing the procedures and steps involved with the present invention. An example of the procedure for the present invention can go as follows: A woman victim successfully argues that her ex-boyfriend has been stalking and threatening violence, so the judge in her jurisdiction issues a protective order as seen in 300. The next step in 310, the ex-boyfriend offender is served notice of the order. Around the same time, in 320, the victim is issued an official dual-sided identification card (15) as described above and exampled in FIG. 1 and FIG. 2. A few weeks later, the victim is at a restaurant in a neighboring county. As the victim is eating, she views the offender walking into the restaurant. The victim promptly calls the police as seen in 330. A police officer enters the restaurant where the officer is greeted by the victim, who attempts to explain the situation but is so shaken that she cannot articulate the issue properly. The victim also did not bring the bulk of court documents with her regarding the protective order. So the victim then removes the dual-sided identification card (15) from her purse and shows the officer her card as seen in 340. The police officer then views the information on the front of the dual-sided identification card (15) and is convinced that the victim matches the description on the card as seen in 350. After locating the alleged offender, the police officer then uses the back of the dual-sided identification card (15) to verify his identity as seen in 360. In 370, the police officer views the dual-sided identification card (15) to learn and verify the specific terms of the court order. In this example, the protective order stated that the offender was not allowed within 1,000 feet of the victim. Since he was in the same restaurant, the officer promptly verified the terms. At this point, the officer uses a telephone to call the national information contact number (120) as seen in 380. After connecting to the automated system, the officer dials in the protective order number (90). An automated response states that the order is indeed valid. Acting under federal law permitting law enforcement officials to enforce protective orders regardless of jurisdiction, the officer arrests the offender in 390.

I claim:

1. A method for the enforcement of court-ordered protective orders comprising:
an officially-issued identification;
a national informational hotline; and
a voucher system;

2. The method of claim 1, wherein said officially issued identification card contains information on the front and rear side.

3. The method of claim 1, wherein said national information hotline contains data-entry of all valid protective orders.

4. The method of claim 1, wherein said voucher system contains information for those agreeing to assist those issued said officially issued identification card.

5. The method of claim 2, wherein said identification card contains information on the victim being protected by a protective order.

6. The method of claim 2, wherein said identification card contains information on the offender subject to a protective order.

7. The method of claim 2, wherein said identification card contains information on the jurisdiction where the protective order was issued.

8. The method of claim 2, wherein said identification card contains information on the terms of the protective order.

9. The method of claim 3, wherein said identification card contains information on the national information hotline.

10. The method of claim 3, wherein said national information hotline provides confirmation on the status all protective orders.

11. The method of claim 4, wherein said voucher system contains coded information.

12. The method of claim 2, wherein said voucher system contains coded information located on said officially issued identification card.

13. A method for the enforcement of court-ordered protective orders comprising
an officially-issued identification card;
a national informational hotline;
a voucher system;
wherein said identification card contains information on the front and rear side;
wherein said national information hotline contains data-entry of all valid protective orders;
wherein said identification card contains information on the victim being protected by a protective order;
wherein said identification card contains information on the offender subject to a protective order;
wherein said identification card contains information on the jurisdiction where the protective order was issued;
wherein said identification card contains information on the terms of the protective order;
wherein said identification card contains information on the national information hotline;
wherein said national information hotline provides confirmation on the status all protective orders;
wherein said voucher system contains coded information; and
wherein said voucher system contains coded information located on said officially issued identification card.
